(19) United States
(12) Patent Application Publication
(10) Pub. No.: US 2009/0096877 A1
(43) Pub. Date: Apr. 16, 2009

(54) CAMERA AND CAMERA SYSTEM

(76) Inventor: Keiji KUNISHIGE, Hachioji-shi (JP)

Correspondence Address: STRAUB & POKOTYLO, 788 Shrewsbury Avenue, TINTON FALLS, NJ, 07724, US

(21) Appl. No.: 12/250,358

(22) Filed: Oct. 13, 2008

(30) Foreign Application Priority Data
Oct. 16, 2007 (JP) 2007-269396

(51) Int. Cl. H04N 5/225

(52) U.S. Cl. 348/207.11; 348/E05.024

(57) ABSTRACT

In a camera system, cameras are connected to a network via network groups, and the network is connected to a personal computer of a control unit. Data transmitted from the personal computer is stored in a memory of each camera. Each camera in a network group selected by the personal computer decides propriety of operation reception for each operation member with reference to operation propriety data stored in the memory at every operation of the operation members of the camera.

### CROSS-REFERENCE TO RELATED APPLICATIONS

This application is based upon and claims the benefit of priority from prior Japanese Patent Application No. 2007-269396, filed Oct. 16, 2007, the entire contents of which are incorporated herein by reference.

### BACKGROUND OF THE INVENTION

1. Field of the Invention

A photo studio chain operates a large number of local photo studios. While even the local photo studios install cameras with multifunction and complicated operations there in, part-time workers who have been inexperienced mostly operate the cameras to photograph.

Meanwhile, as disclosed in Jpn. Pat. Appln. KOKAI Publication No. 2006-238020, a technique for remotely operating cameras connected via a network has been known.

2. Description of the Related Art

Major photo studio chain stores operate photo studios of a large number of local branches. Cameras sent from their headquarters are installed in photo studios of local branches. Setting conditions for the photo studios which have been preset by the headquarters are set to the installed cameras.

The cameras are started before opening the photo studios every day and started under the preset setting conditions for the photo studios.

A technique, which remotely controls photographing operations of a plurality of other cameras from the camera in the headquarters, is disclosed, for example, in Jpn. Pat. Appln. KOKAI Publication. No. 2006-238020.

### BRIEF SUMMARY OF THE INVENTION

An object of the invention is to provide a camera and a camera system configured to provide photographs with stable quality even at a photo studio with a skilled cameraman not stationed therein or a photo studio located at a remote place, and to prevent a business chance from being lost without requiring excessive labor due to sudden maintenance accompanied by a setting change.

An object of the present invention is to provide a camera comprising:

a photographing unit which photographs an object;

an image memory which stores an image photographed

with the photographing unit;

a plurality of operation members which receive operations

by a user;

a camera controller which controls operations of each unit

of the camera including the photographing unit in response to the operations by the operation member;

a control information memory which stores control

information for deciding propriety of reception of operations for each operation member; and

a communication unit which transmits and receives

information to and from an external controller via a network, wherein

the camera controller stores the control information transmitted from the external control device and received by the communication unit in the control information memory, and when the operations of the operation member have been detected, determines the propriety of the reception of the operations by referring to the control information stored in the control information memory.

Another object of the invention is to provide a camera comprising:

a photographing unit which photographs an object;

an image memory which stores an image photographed with

the photographing unit;

a plurality of operation members which receive operations by a user;

a camera controller which controls an operation of each

unit of the camera including the photographing unit in response to the operation by the operation member;

a control information memory which stores control

information for deciding propriety of reception of the operations for each operation member; and

a storage medium mounting unit which mounts an attachable and detachable storage medium thereon;

wherein

the camera controller reads the control information from the storage medium mounted on the storage medium mounting unit to store the control information in the control information memory, and when the operations of the operation member have been detected, determines the propriety of the reception of the operations by referring to the control information stored in the control information memory.

Another object of the invention is to provide a camera system configured to include at least one camera connected to a network, and a control device connected to the network, wherein the camera comprises:

a photographing unit which photographs an object;

an image memory which stores an image photographed by the photographing unit;

a plurality of operation members which receive operations by a user;

a camera controller which controls an operation of each unit of the camera including the photographing unit in response to the operations of the operation member;

a control information memory which stores control information for deciding propriety of reception of operations for each operation member; and

a first communication unit which transmits and receives information to and from the control device via the network; wherein

the control device comprises:

a second communication unit which communicates with the camera via the network;

a selection unit which selects as least one of the cameras connected to the network; and

an operation setting unit which generates the control information for deciding the propriety of the reception of the operations for each operation member of the camera selected by the selection unit,

the control device makes the second communication unit transmit the control information generated from the operation setting unit to the camera selected by the selection unit; and

the camera controller stores the control information received by the first communication unit in the control information memory, and determines the propriety of the reception of operations of each operation member by referring to the control information stored in the control information memory for each operation of the operation members in the camera selected by the selection unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1A is a block diagram schematically depicting a configuration of a camera system of an embodiment of the invention, and FIG. 1B is a view for explaining an example in which communication between a personal computer and cameras is performed by means of a memory card;

FIG. 2 is a block diagram depicting a configuration of an electric system of digital cameras connected to a network 20 and network groups 36₁, 36₂, 36₃, . . . , of FIG. 1A;

FIG. 3 is a rear view depicting an appearance of a camera to be used in a camera system of the embodiment of the invention;

FIG. 4 is a table depicting install positions of operation members of a camera 40 and choices capable of permitting or prohibiting operations;

FIGS. 5A and 5B flowcharts for explaining operations of the camera system of the embodiment of the invention, and explaining execution operations of application software in a personal computer 32 of a control unit 30;

FIG. 6 is a view depicting a display example of an application screen view by means of application software;

FIG. 7 is a flowchart for explaining operations of a sub-routine “camera information display” in a Step S13 of the flowchart of FIG. 5B;

FIG. 8 is a view depicting a display example of an application screen for explaining a camera information display;

FIG. 9 is a view depicting another display example of the application screen for explaining the camera information display;

FIG. 10 is a flowchart for explaining operations of sub-routine “scanning processing” in Step S15 of the flowchart of FIG. 5B;

FIG. 11 is a view depicting a display example of an application screen for explaining the “scanning processing”;

FIG. 12 is a flowchart for explaining operations of sub-routine “camera setting processing” in Step S17 of the flowchart of FIG. 5B;

FIG. 13 is a view depicting a display example of an application screen for explaining the “camera setting processing”;

FIG. 14 is a flowchart for explaining operations of sub-routine “start data setting processing” in Step S19 of the flowchart of FIG. 5B;

FIG. 15 is a view depicting a display example of an application screen for explaining the “start date setting processing”;

FIG. 16 is a view depicting another display example of the application screen for explaining the “start data setting processing”;

FIG. 17 is a flowchart for explaining operations of sub-routine “storage processing” in Step S21 of the flowchart of FIG. 6; and

FIGS. 18A and 18B are flowcharts for explaining operations of the camera system of the embodiment of the invention, and for explaining operations of cameras 40Ns connected to a network group.

### DETAILED DESCRIPTION OF THE INVENTION

The following will describe embodiments of the invention with reference to the drawings.

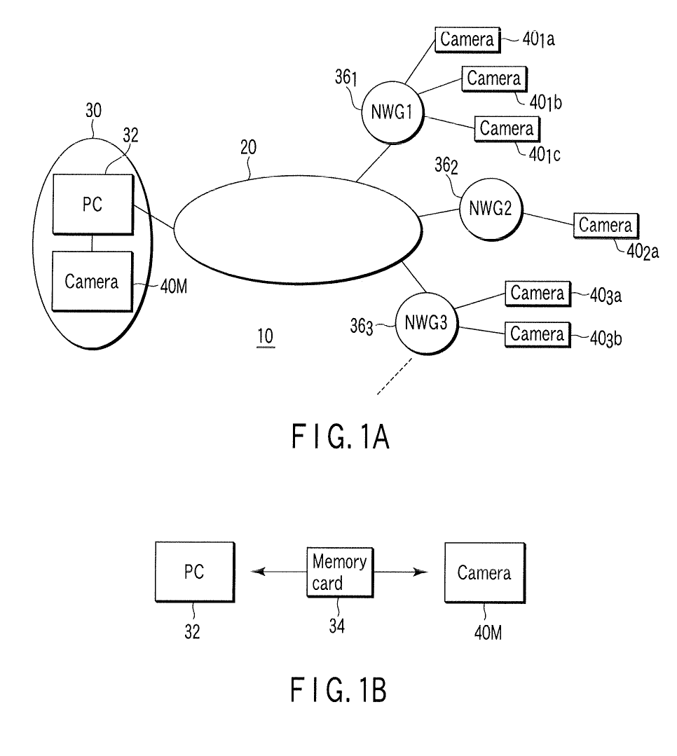

FIG. 1A shows a block diagram schematically depicting a configuration of a camera system of one embodiment of the invention.

In FIG. 1A, in a camera system 10, a control unit 30 that is headquarters and a plurality of network groups (NWG1, NWG2, NWG3, . . . , ) 36₁, 36₂, 36₃, . . . , consisting of sub-networks are connected to one another via a network 20.

A control unit 30 is composed of a personal computer (PC) 32 and a digital camera 40M. This digital camera 40M acts as a master camera 40M in the camera system 10. The PC 32 and the master camera 40M are directly connected with each other through a cable, etc.

The network groups 36₁, 36₂, 36₃, . . . , indicate, for example, a group name of each camera installed in each photo studio. A plurality of digital cameras 40₁a, 40₁b, 40₁c, . . . , 40₂a, . . . , 40₃a, 40₃b, . . . , are connected to the network groups 36₁, 36₂, 36₃, . . . , respectively. Thereby, communication is performed among digital cameras 40₁a, 40₁b, 40₁c, . . . , 40₂a, . . . , 40₃a, 40₃b, . . . , and the PC 32 via the network 20 and the network groups 36₁, 36₂, 36₃, . . . .

Meanwhile, the camera system 10 may be configured so that the control unit 30 (PC 32) and the digital cameras 40₁a, 40₁b, 40₁c, . . . , 40₂a, . . . , 40₃a, 40₃b, . . . , which have been installed at the photo studios, are connected to one another via a memory card 34 that is a storage medium, as is shown in FIG. 1B.

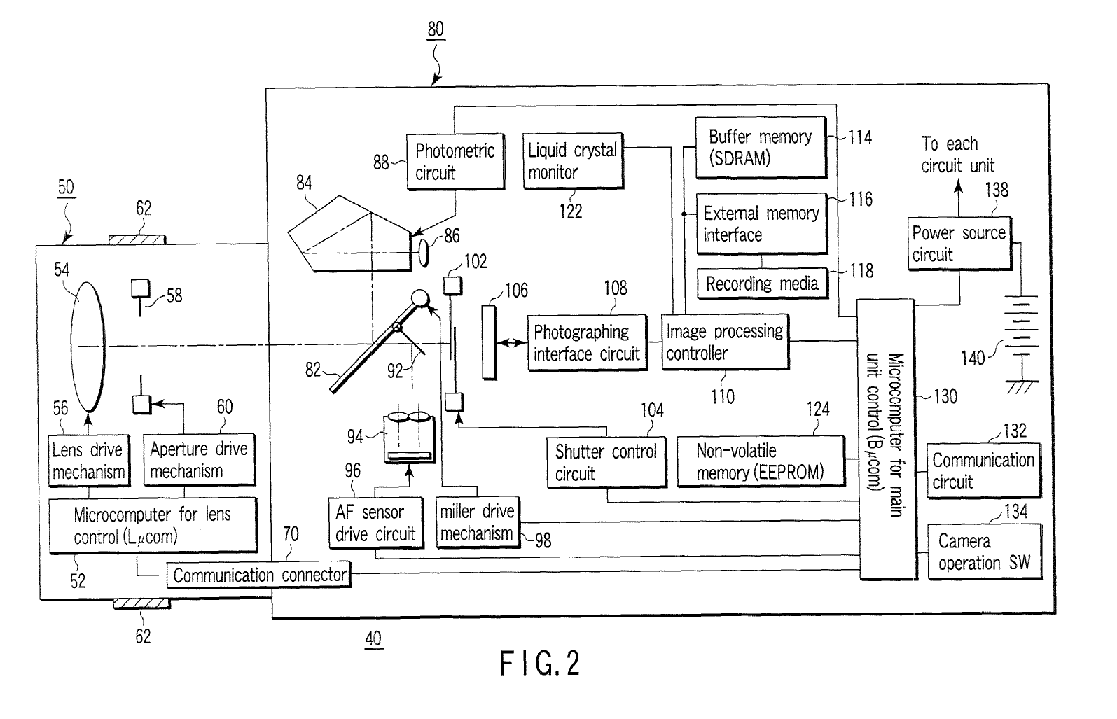

FIG. 2 shows a block diagram illustrating a configuration of an electric system of digital cameras 40₁a, 40₁b, 40₁c, . . . , 40₂a, . . . , 40₃a, 40₃b, . . . , connected to such a network 20 and network groups 36₁, 36₂, 36₃, . . . . Here, although the digital camera is described as the digital camera 40, any of the master camera 40M and cameras 40₁a, 40₁b, 40₁c, . . . , 40₂a, . . . , 40₃a, 40₃b, . . . , which have been connected to and each network group 36₁, 36₂, 36₃, . . . , is configured basically in the same way. The digital camera is abbreviated to a camera in the following description.

The camera system 10 includes a camera main unit 80, and a lens barrel 50 which is freely attachable/detachable to the main unit 80.

The lens barrel 50 includes a microcomputer for lens control (hereinafter referred to as an Lμcom) 52 for lens control which controls each part in the lens barrel 50. The Lμcom 52 is communicably connected to a microcomputer for body control (hereinafter referred to as Bμcom) 130 which controls each unit in the main unit 80 via a communication connector 70 and is described in detail later. That is, when the lens barrel 50 is mounted at the camera main unit 80, the Lμcom 52 and the Bμcom 130 are communicably connected via the communication connector 70. In this case, the Lμcom 52 operates in a way so as to be dependent on the Bμcom 130, as the camera system 10.

Within the lens barrel 50, a photographing optical system 54 is disposed. In FIG. 2, the optical system 54 includes a photographing lens for deciding a focus position of an object image. The photographing lens included in the optical system 54 is moved in an optical axis direction by means of a direct-current motor which is disposed, but not shown, in a lens drive mechanism 56.

An aperture 58 is disposed on an optical axis and at the rear of the optical system 54. The aperture 58 is opened and closed by a stepping motor which is disposed, but not shown, in an aperture drive mechanism 60. Controlling the opening and closing of the aperture 58 controls the quantity of light of a light flux which is incident from an object to the camera main unit 80 via the optical system 54.

Here, the Lμcom 52 which has received a command from the Bμcom 130 controls the direct-current motor in the lens drive mechanism 56 and controls the stepping motor in the aperture drive mechanism 60. When a focus ring 62, which is a rotatable member which is provided around the lens barrel 50, is rotated by a user, the lens drive mechanism 56 drives the photographing lens included in the optical system 54 in synchronous with the rotation. That is, the focus ring 62 is a member for being manually focused by the user.

Meanwhile, a finder device consisting of a main mirror 82, a penta-prism 84, and an ocular lens 86 is disposed inside the camera main body 80. In a case in which the master camera 40M is in a normal status, the main mirror 82 reflects a part of the light flux which has been made incident through the optical system 54 from the object (not shown). Thereby, an image for observation is focused through the penta-prism 84 and the ocular lens 86.

A photometric circuit 88 is disposed near by the penta-prism 84. In the photometric circuit 88, a part of the light flux passing through the penta-prism 84 is incident to a photo sensor (not shown) in the photometric circuit 88. The photometric circuit 88 performs well known photometric processing on the basis of the quantity of light of the light flux detected by the photo sensor. The result processed by the photometric circuit 88 is transmitted to the Bμcom 130.

The Bμcom 130 calculates a quantity of light of exposure in photographing on the basis of the result input from the photometric circuit 88. The result is transmitted from the Bμcom 130 to the Lμcom 52. The Lμcom 52 controls the drive of the aperture 58 on the basis of the quantity of exposure light reported from the Bμcom 130.

The light flux of the object which is not reflected from the main mirror 82 passes through the main mirror 82 to be reflected from a sub-mirror 92 disposed on the side of the rear surface of the main mirror 82, and the reflected light flux is guided to an AF (automatic focusing) sensor unit 94 for performing automatic focusing processing (AF processing). An area sensor (not shown) is disposed inside the AF sensor unit 94, and the light flux which is made incident to the area sensor is converted into an electric signal.

An output from the area sensor is transmitted to the Bμcom 130 through an AF sensor drive circuit 96. The Bμcom 130 conducts photometric processing and calculates a focus status (quantity of defocus) of the photographing optical system 54 needed for automatic focusing. The calculation result is transmitted from the Bμcom 130 to the Lμcom 52. The Lμcom 52 calculates a quantity of movement of the photographing lens of the optical system 54 on the basis of a quantity of defocus reported from the Bμcom 130. The Lμcom 52 controls the drive of the photographing lens of the optical system 54, based on the quantity of the movement.

Meanwhile, when the camera 40M is in an operating state, the main mirror 82 is moved to a prescribed up position (not shown) at which the optical system 54 gets away from the light axis of the optical system 54. Such a drive of the main mirror 82 is conducted by a mirror drive mechanism 98. The control of the dive mechanism 98 is performed by the Bμcom 130. Here, if the main mirror 82 is moved to the up position, the sub-mirror 92 is folded as the main mirror 82 is moved to the up position.

In this way, moving the main mirror 82 to the up position makes the light flux from the object which has passed through the optical system 54 incident in a direction of a shutter unit 102 arranged at the rear of the main mirror 82 on the light axis. The light flux which has passed through the shutter unit 102 is made incident to a photographing element 106 disposed at the rear of the shutter unit 102. The shutter unit 102 is a focal-plane shutter consisting of a front curtain and a rear curtain. Driving of the front curtain and the rear curtain is conducted by a shutter control circuit 104. The shutter control circuit 104 is controlled by the Bμcom 130.

The light flux of the object image which has been focused by the photographing element 106 is converted into an electric signal (video signal). The electric signal is read through a photographing interface circuit 108 at each prescribed timing, and the read electric signal is output as image data. The image data is stored in a buffer memory 114 composed of an SDRAM, etc., through an image processing controller 110. Here, the buffer memory 114 is a memory for temporal storage of the data such as image data, and for being utilized as a work area, etc., in applying a variety of kinds of processing to the image data.

After this, the image data, which has been read through the interface circuit 108 to be stored in the buffer memory 114, is read by the processing controller 110. The image data which has been read by the processing controller 110 is stored in the buffer memory 114 after being applied in a well known image processing such as a white balance correction, a gradation correction and a color correction.

In recording the image, the image data which has been processed by the processing controller 110 is compressed in a well known compression system such as a JPEG format. The JPEG image data obtained through the JPEG compression is stored once in the buffer memory 114. After this, the JPEG data is recorded on a recording media 118 such as a memory card which is freely attachable and detachable to the camera 40 via an external memory interface 116.

In reproducing the image from the JPEG file recorded in the recording medium 118, the JPEG data recorded in the recording medium 118 is read to be extended by means of the processing controller 110.

Then, after the extended data is converted into a video signal, the video signal is resized to a prescribed size for a display and output to be displayed on a liquid crystal monitor 122.

A non-volatile memory 124 for storing a prescribed control parameter which is necessary for camera control is accessibly connected to the Bμcom 130. The non-volatile memory 124 is composed of, for example, a rewritable EEPROM.

A communication circuit 132 for transmitting and receiving information by wire or radio to and from external equipment and a camera operation switch (camera operation SW) 134 for detecting operation states of various operation members of the camera 40 are connected to the Bμcom 130.

Further, a battery 140 as a power source is connected to the Bμcom 130 via a power source circuit 138. A voltage of the battery 140 is converted into a voltage required by each unit of the camera system 10 by the power source circuit 138 to be supplied to each unit of camera system 10.

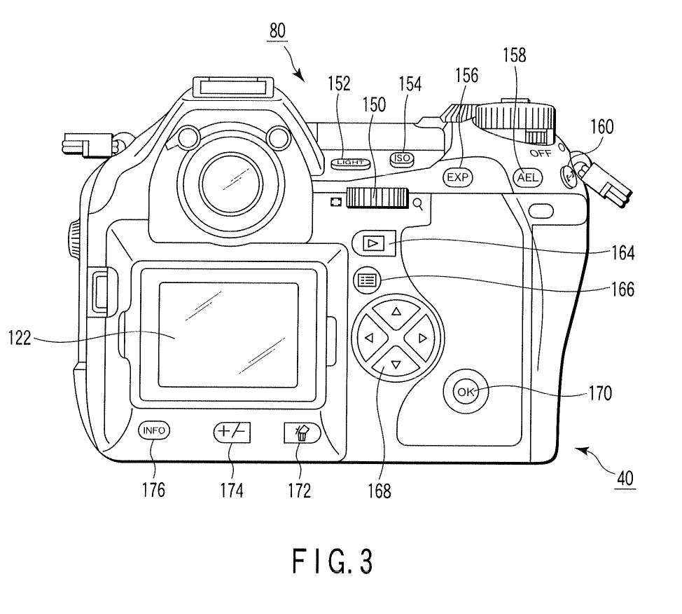

The various operation members of the camera 40 will be described with reference to FIG. 3.

FIG. 3 is a rear face view illustrating an appearance of a camera to be used in the camera system of the embodiment.

As shown in FIG. 3, the rear face of the camera 40 is provided with a main dial 150, a “Light” button 152, an ISO button 154, an exposure mode button 156, an AE lock button 158, a white balance (WB) button 160, a reproduction mode button 164, a menu button 166, a cross button 168, an “OK” button 170, a deletion button 172, a “+/−” button 174, an “INFO” button 176 and a an LCDmonitor 122.

The main dial 150 is a member to be rotated for setting a function of an operation member which is currently pressed by the user.

The “LIGHT” button 152 is a button for popping up a built-in flash light. By pressing the “LIGHT” button 152, the flash light housed in the camera main unit 80 is popped up and brought into an available state.

The ISO button 154 is a button for setting ISO sensitivity of the camera 40. In a state in which the ISO button 154 has been pressed, operating the main dial 150 increases the ISO sensitivity of the camera 50 step by step in accordance with a prescribed value (e.g., 100). If the main dial 150 is rotated in an opposite direction, the ISO sensitivity decreases step by step in accordance with the prescribed value. Or, if the main dial 150 is rotated in a state in which the ISO button 154 has been pressed, the ISO sensitivity is changed as described below. That is, the ISO sensitivity is changed as follows: 100→200→400→800→1600. If the main dial 150 is rotated in an opposite direction, the ISO sensitivity may be changed as follows: 1600→800→400→200→100.

The exposure mode button 156 is a button for selecting the exposure mode of the camera 40. The exposure mode includes a program mode, an aperture priority mode, a shutter speed priority mode, a manual mode and a “My Mode” (custom mode). In a state in which the exposure mode button 156 has been pressed, operating the main dial 150 switches the exposure of the camera 40 in the order, for example, as follows: a program mode an aperture priority mode a shutter speed priority mode→a manual mode→a custom mode→, . . . . If the main dial mode 150 is rotated in an opposite direction, the exposure mode of the above is switched in a reverse order.

The AE lock button 158 is a button for fixing an exposure condition. The amount of exposure is fixed while the AE lock button 158 is pressed.

The WB button 160 is a button for switching the white balance mode of the camera 40. In a state in which the WE button 160 has been pressed, operating the main dial 150 switches the white balance mode in the order: “AUTO”→fine weather→cloudy weather→shade→, . . . . If the main dial 150 is rotated in an opposite direction, the white balance is switched in order: shade→cloudy→weather→fine weather→“AUTO”→, . . . .

The reproduction mode button 164 is a button for switching an operation mode of the camera 40 into a reproduction mode in which an image may be reproduced and displayed on the liquid crystal monitor from the JPEG file recorded in the recording media 118.

The menu button 166 is a button for displaying a menu screen on the monitor 122. The menu screen includes menu items composed of a plurality of hierarchy structures. The user may select a desired menu item by the cross button 168 and decide the item which has been selected by the “OK” button 170.

The menu items include a photography menu capable of setting set-up of the recording medium 118, image-quality of image data, image processing, and scene mode; a reproduction menu capable of setting reproduction conditions in image reproduction, and image print; a custom menu capable of setting in detail in response to a user's taste; and a set-up menu for setting an operation state of the camera 40, such as kinds of beep tones.

The deletion button 172 is a button for deleting the image data (JPEG file) in the reproduction mode from the recording medium 118.

The “+/−” button 174 is a button for correcting exposure in photography. In a state in which the “+/−” button 174 has been pressed, operating the main dial 150 increases the exposure in the order: 0EV→1EV→2EV→3EV from a current exposure state. Conversely, if the main dial 150 is rotated inversely, the exposure decreases in the order: 0EV→−1EV→−2EV→−3EV.

The information display button 176 is a button for displaying the image information based on additional information (e.g., Exif information) of the image data.

In addition to foregoing operation members, various operation members are disposed on the upper surface or the front surface of the camera 40.

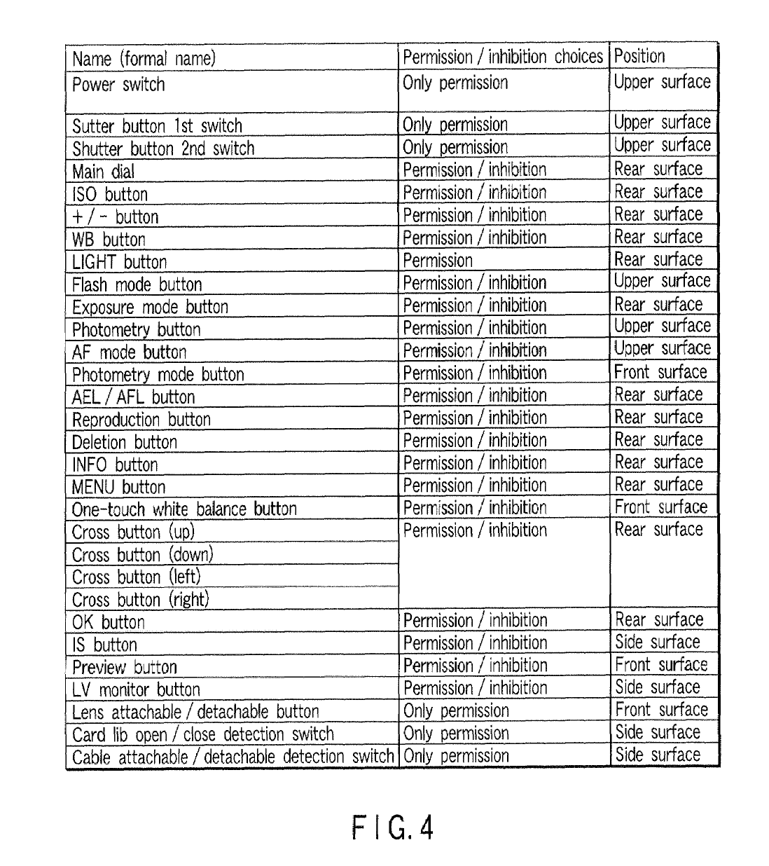

FIG. 4 shows a table showing the install positions of the operation members including the aforementioned various operation members of the camera 40, and the choices capable of permitting or inhibiting operations. Setting permission or inhibition of the operations of the operation members decides the permission or inhibition of the operations of the corresponding-functions.

However, as regards a part of the operation members, the Bμcom 130 determines permission/inhibition of acceptance of the operations. The contents which have been set by the user through the operations of each operation member and information of the propriety (permission/inhibition) of the operations are stored in the buffer memory 114 or a memory (not shown) in the Bμcom 130.

The setting values of the camera 40 which have been set by the operation members are stored in a built-in memory (not shown) of the camera 40 when a power switch (not shown) of the camera 40 is turned off. When the power switch of the camera 40 has been brought into an “on” state from an “off” state, the setting state stored in the built-in memory is read to be set by the Bμcom 130.

Version information of the firmware and the number of times of photographing after the camera 40 is manufactured are stored in a memory (not shown) of the Bμcom 130 of the camera 40.

Further, the camera 40 has a function of transmitting the aforementioned various items of information such as the operation member permission/inhibition information, camera setting information, version information of the firmware, and the number of times of photographing to the application software of the PC 32 of the control unit 30. The camera 40 has a function of receiving the operation member permission/inhibition information, and the camera setting information to the application software. The camera 40 has a function of receiving the operation member permission/inhibition information, and the camera setting information from the application of the PC 32, and also has a function of changing the camera setting on the basis of the received data.

The camera 40 has a function of writing the operation member permission/inhibition information, the camera setting information, the version information of the firmware, and the number of times of photographing in the memory card 34 on the basis of the prescribed format. In addition, The camera 40 has a function of reading the operation member permission/inhibition information and the camera setting information written in the memory card 34 in a prescribed format, and a function of changing the camera setting, based on the read data.

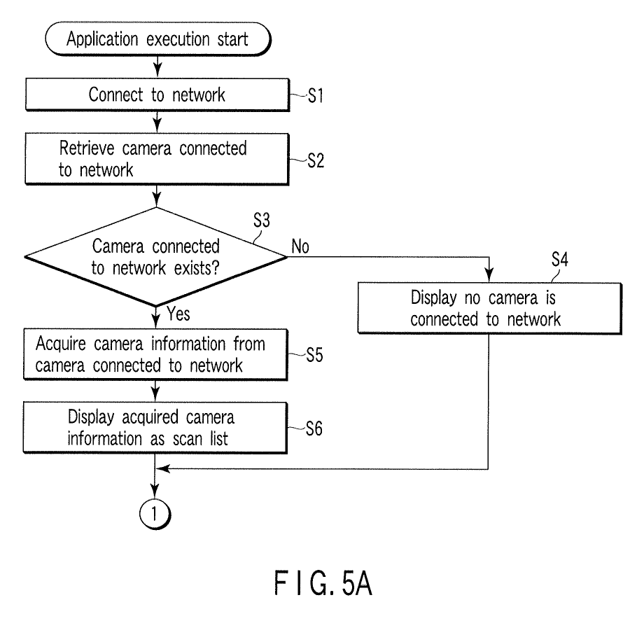

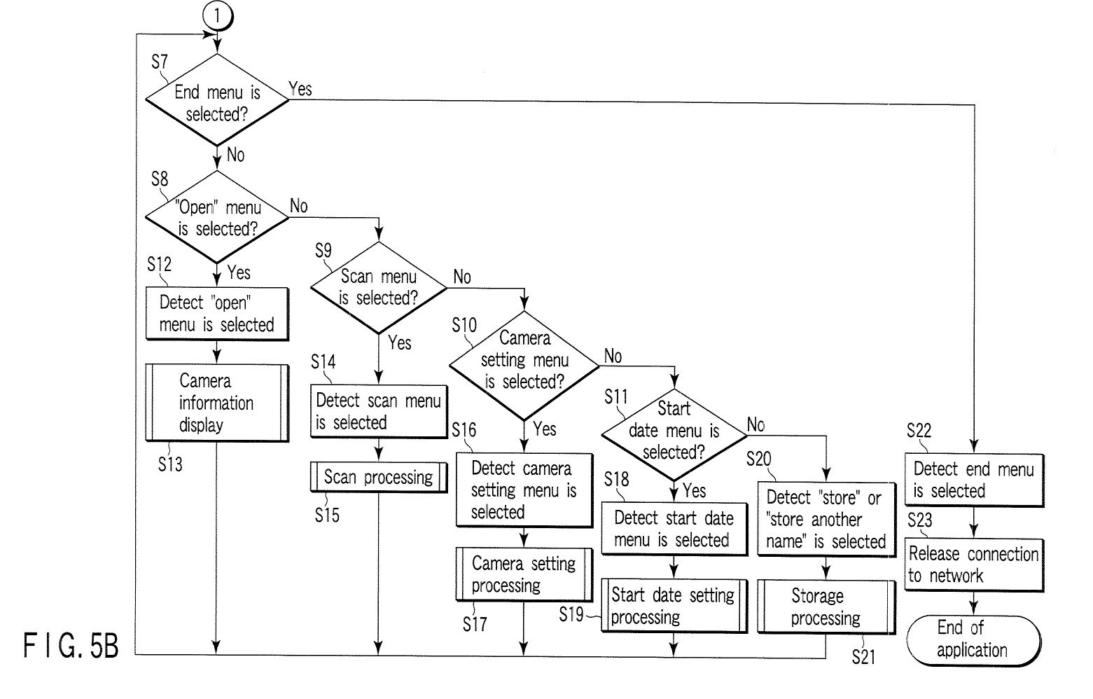

The following will describe operations of the camera system 10 of the embodiment with reference to FIGS. 5A and 5B to 18A and 18B.

In the following description, it is assumed that the camera at the control unit is set to the camera 40M, and the camera 40N (reference number is not shown) is a representative camera connected to each network group.

At first, execution operations of the application software of the PC 32 at the control unit 30 will be described by referring to the flowcharts of FIGS. 5A and 5B.

The application software has a function of communicating with the camera 40N to receive the foregoing operation member permission/inhibition information, camera setting information, firmware version information, and information of the number of times of photographing, a function of editing the received operation member permission/inhibition information, and camera setting information, and a function of transmitting the edited operation member permission/inhibition information, and camera setting information to the camera 40N.

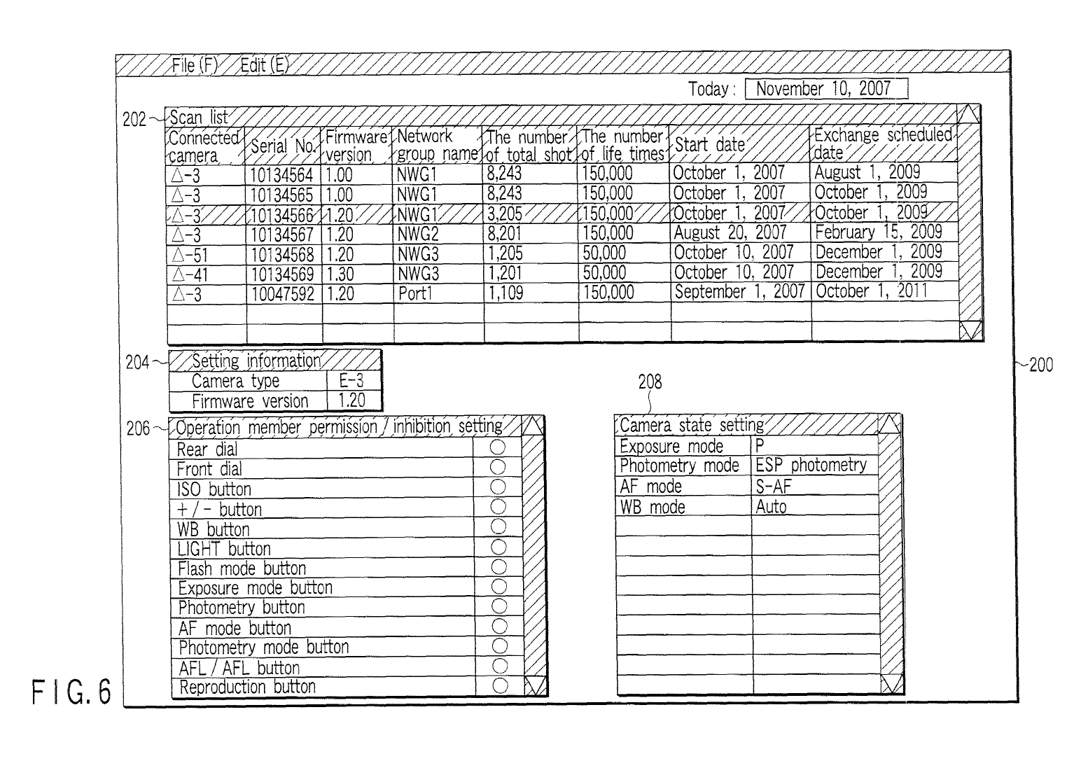

When the application software is started, the application screen 200 shown in FIG. 6 is initiated. For instance, the application screen 200 displays a scan list window 202, a setting information window 204, an operation member permission/inhibition setting window 206, and a camera state setting window 208. These windows are displayed in a way described hereinafter.

When the application is initiated at the PC 32 of the control unit 30, the camera 40N is connected to the network 20 in Step S1. The camera 40N connected to the network 20 is retrieved in Step S2. In this case, all the cameras connected with one another through each network group are retrieved.

The camera system 10 determines the presence or absence of the camera 40N connected to the network 20 in Step S3. If there is no camera 40N connected to the network 20, the system 10 displays the fact on the screen, and then, shifts to Step S7. Conversely, if it is determined that there is the camera 40N connected to the network 20 in Step S3, the system 10 shifts to Step S5. In Step S5, the information of cameras from all the cameras connected to the network 20 is acquired. In Step S6, the camera information acquired in Step S5 is displayed on the application screen 200 as the scan list window 202.

In Steps S7-S11, the system 10 operates a mouse, etc., (not shown) to select various menus from a pull-down menu of a menu bar on the application screen 200.

Firstly, it is determined whether or not an end menu has been selected in Step S7. If the end menu has been selected, the system 10 shifts to Step S22 mentioned later, and if the end menu has not been selected, the system 10 shifts to Step S8. In Steps S8-S11, it is determined whether or not any one of an “open” menu, a scanning menu, a camera setting menu and a start date menu has been selected.

If the “open” menu has been selected, it is detected that the “open” menu has been selected in Step S12. Then, a sub-routine “camera information display” is carried out in Step S13.

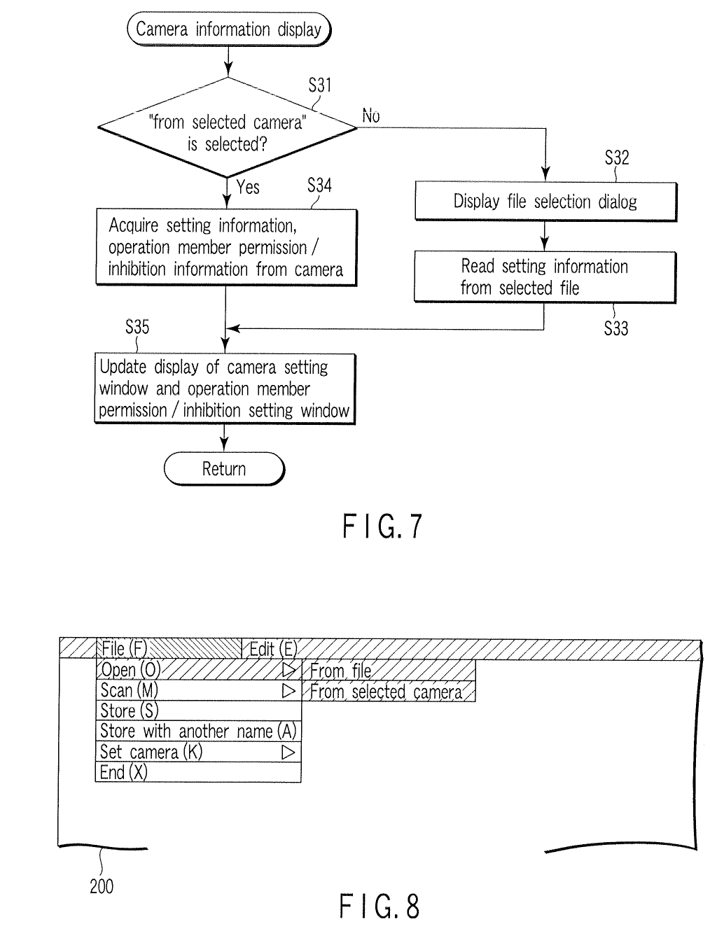

FIG. 7 is a flowchart for explaining operations of a sub-routine “camera information display” in Step S13 of the flowchart of FIG. 5B.

After entering this sub-routine, it is determined whether or not a sub-routine “from selected camera” has been selected in Step S31. If the sub-routine “from selected camera” has not been selected, the system 10 shifts to Step S32 to display a file selection dialog. The setting information is read from the selected file in Step S33. After this, the system 10 shifts to Step S35.

Conversely, if the sub-routine “from selected camera” has been selected in Step S31, the system 10 shifts to Step S34. Then, the system 10 acquires the setting information and the operation member permission/inhibition setting information by means of the camera 40N in Step S34.

In other words, when the left button of the mouse (not shown) is operated and clicked at the camera position displayed in the scan list window 202, the camera 40 is brought into focus. As shown in FIG. 8, when “file (F)”→“open (O)”→“from selected camera” are clicked by the left button of the mouse, the application software communicates with the camera 40N connected to the head of each network group. The setting information of the camera 40N is displayed in the operation member permission/inhibition setting window 206 and in the camera state setting window 208 on the application screen 200.

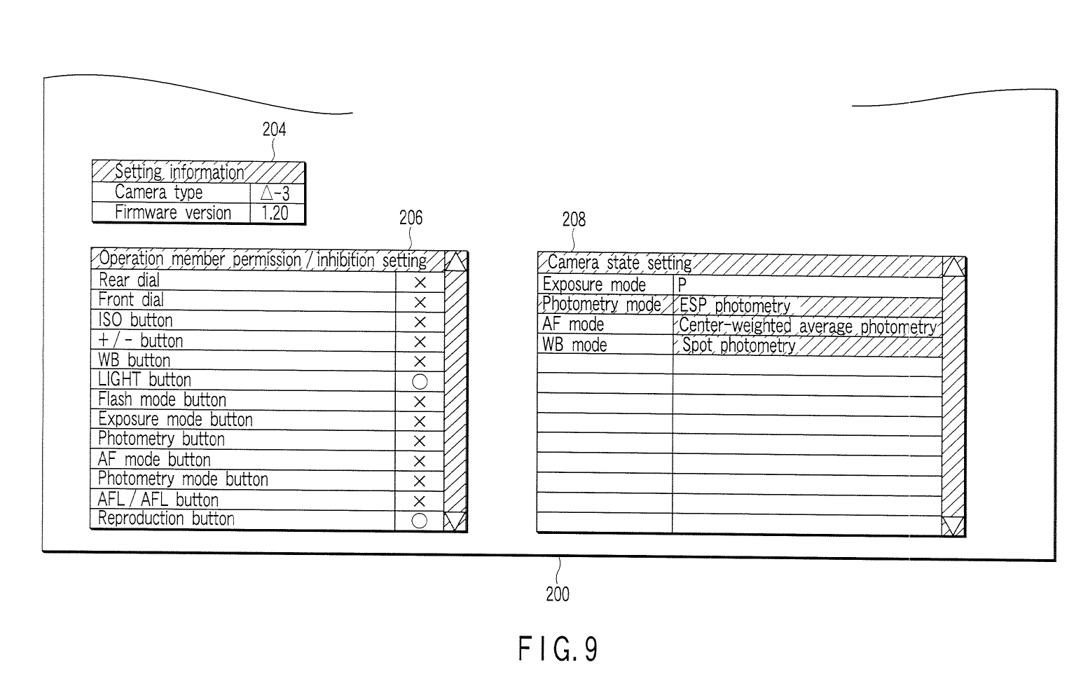

When the “file (F)”→“open (O)”→“from file” are clicked by the left button of the mouse from the menu bar, the application software starts a file reading dialog. Thereby, the file specified through the file reading dialog, i.e., the content is displayed in the setting windows 206, 208 on the screen 200 as shown in FIG. 9.

In Step S35, the system 10 updates the display in the windows 206, 208. That is, in the setting window 208 on the screen 200, by changing ◯ into X, the system 10 may instruct reception inhibition of the operation member to the camera 40N. Further, in the window 208 on the screen 200, the position of a targeted mode is clicked by the left button of the mouse, the displayed selection menu is further clicked by the left button of the mouse, and then, a camera state instruction may be changed.

After this, the system 10 passes through this sub-routine, shifts to Step S7 of the flowchart of FIG. 5B and enters a state of waiting the operations.

If the scan menu has been selected in Steps S8-S11, it is detected that the scan menu has been selected in Step S14. Then, the sub-routine “scan processing” is carried out in Step S15.

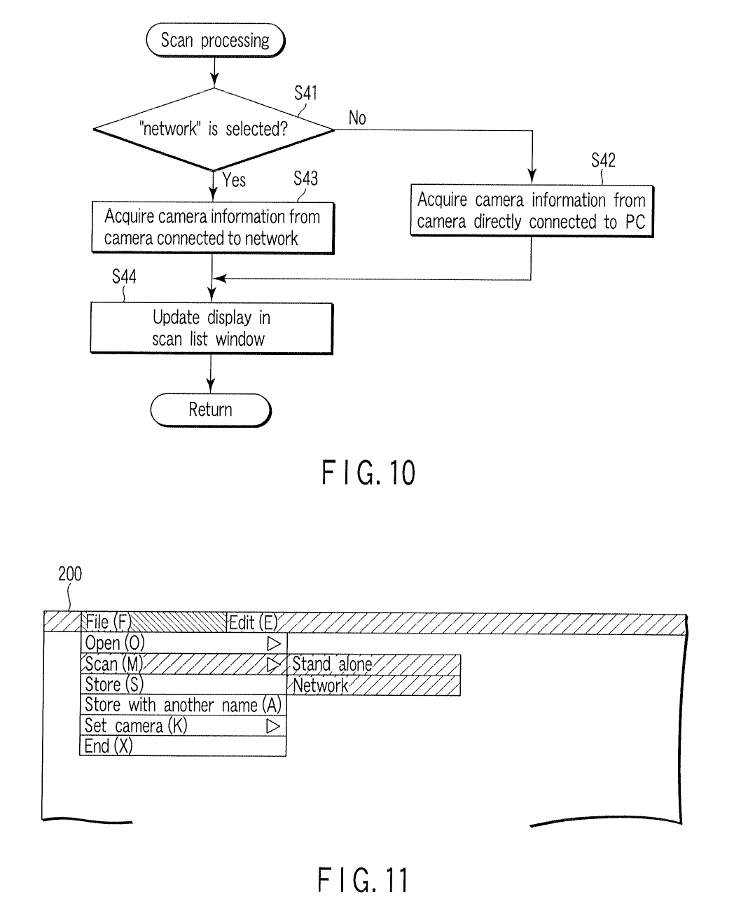

FIG. 10 shows a flowchart for explaining operations of the sub-routine “scan processing” in Step S15 of the flowchart of FIG. 5B.

After entering this sub-routine, it is determined whether or not a sub-routine “network” has been selected in Step S41. If the “network” has not been selected, the system 10 shifts to Step S42 to acquire the camera information from the master camera 40M directly connected to the PC 32. This is a case in which the PC 32 and the camera 40M are connected with each other by a cable, etc. and not via the network. After this, the system 10 shifts to the Step S44.

Meanwhile, if the sub-routine “network” has been selected in Step 541, the system shifts to step S43 to acquire the camera information from all the cameras 40N connected to the network 20.

That is, as shown in FIG. 11, the “file (F)”→“scan (M)”→“stand alone” are clicked by the left button of the mouse from the menu bar on the screen 200. Then, the application software communicates with the cameras, and the information on all the cameras, which are currently connected to the PC 32 via the network 20, are displayed in the scan list window 202 on the application screen 200.

If the “file (F)”→“scan (M)”→“network” are clicked by the left button of the mouse from the menu bar on the screen 200, the application software communicates with the camera 40N. The scan list window 202 on the application screen 200 displays the information on all the cameras currently connected to the PC32 via the network 20.

The screen information displayed on the window 202 is, for example, as follows: “name of camera”, “serial number”, “firmware version (firm version)”, and “the number of total shots” that is the number of shots taken at a studio up to this time, “the number of Life times” of a quality guarantee, “photographing start date”, which is a photographing start time at a studio, “exchange scheduled date”, etc. (refer to FIG. 6).

Among the above, “the number of life times” is different for each kind of camera. As regards the “exchange scheduled data”, the exchange scheduled date is calculated to be displayed from the information of “the number of total shots”, “the number of life times” and the “photographing start date” by the following formula:

$$Exchange date = \frac{( the number of life times )}{( \frac{[ the number of total shots )}{( today - start date )} )} + start date$$

In Step 44, when the display in the scan list window 202 has been updated, the system 10 passes through this sub-routine to shift to Step S7 of the flowchart of FIG. 5B, and the system 10 enters a state of awaiting operations.

If the camera setting menus have been selected in Steps S8-S11, it is detected that the camera setting menu has been selected in Step S16, and the sub-routine “camera setting processing” is carried out in Step S17.

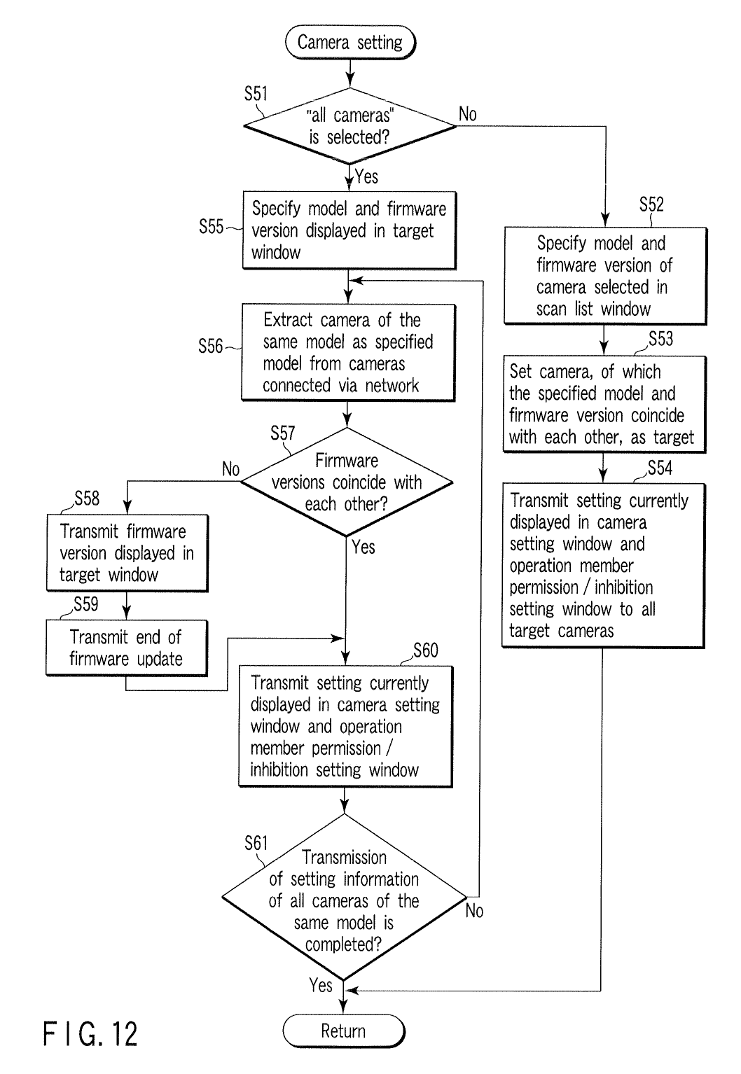

FIG. 12 shows a flowchart for explaining operations of the sub-routine “camera setting processing” in Step S17 of the flowchart of FIG. 5B.

When entering this sub-routine, it is determined whether or not the sub-routine “all cameras” has been selected in Step S41. If “all cameras” has not been selected, the system 10 shifts to Step S52 to specify the model and the version of the firmware of the camera 40N selected in the scan list window 202.

In step S53, the camera 40N of which the version of the firmware coincides with the specified model of the camera is set as a target. Then, in the next Step S54, the setting currently displayed in the camera state setting window 208 and the operation member permission/inhibition setting window 206 is transmitted to all the targeted cameras 40Ns. After this, the system 10 passes through this sub-routine, and shifts to Step S7 of the flowchart of FIG. 5B to be brought into a state of awaiting operations.

Conversely, in Step S51, if “all cameras” has been selected, the system 10 shifts to Step S55 to specify the model and the version of the firmware displayed in a target window. In Step S56, the camera of the same model as the specified model of the camera is extracted from the cameras 40Ns connected via the network 20.

The version of the firmware is determined in Step S57. If the versions of the firmware do not coincide with each other, the system 10 shifts to Step S58 to transmit the firmware of the version displayed on the target window. In Step S59, if the fact of the end of the update of the firmware has been transmitted, the system shifts to Step S60.

If the versions of the firmware coincide with each other in Step S57, or if update has been ended even if the versions do not coincide with each other, the system shifts to Step S60. In this Step S60, the setting, which is currently displayed in the camera state setting window 208 and the operation member permission/inhibition window 206, is transmitted. It is determined whether or not the transmission of the setting information on the cameras of the same model has completed. If the transmission has not completed, the system 10 shifts to Step S56 and repeats the processing operations in Step S56 or later.

Conversely, if the transmission has completed, the system 10 passes through this sub-routine to shift to Step S7 in the flowchart of FIG. 5B, and enters a state of awaiting operations.

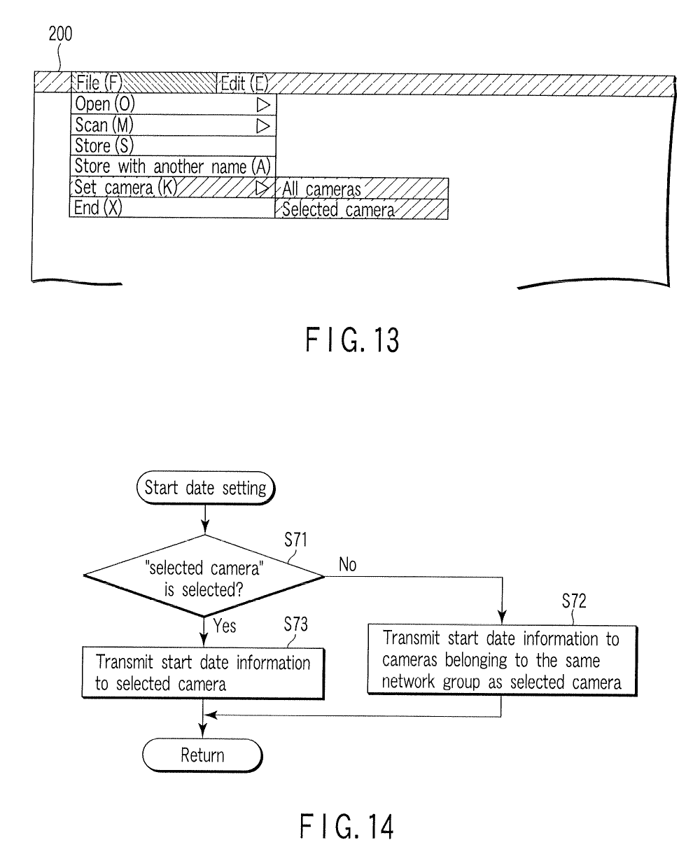

When the “file (F)” →“camera setting (K)”→“all cameras” are clicked by the left button of the mouse from the menu bar, as is shown in FIG. 13, the application software communicates with the camera 40N. Then, communication is performed with appropriate models among the cameras displayed in the scan list window 202 on the application screen 200. Thereby, the setting which has been displayed in the operation member permission/inhibition setting window 206 and in the camera state setting window 208 on the application screen 200 is set to the camera N. Afterward, the camera N holds this state and starts up every time power is turned on.

It is determined whether or not the camera is a suitable model in accordance with whether or not the camera model and the firm version in the setting information window 204, which is the source of state setting, coincide with each other. If the firm version does not coincide with the camera model, the firm version is automatically updated, and the setting is performed after the model is made suitable.

When the “file (F)”→“camera setting (K)”→“selected camera” are clicked by the left button of the mouse from the menu bar, the application software communicates with the camera 40N. The application software communicates with a suitable model among the cameras 40Ns which have been displayed in the setting windows 203, 208 on the application screen 200. Thereby, the setting displayed in the setting windows 206, 208 on the application screen 200 is set in the selected camera. After this, the camera 40N stores this state and starts up from this state at every power-on.

If the start date menu has been selected in Steps S8-S11, it is detected that the start date menu has been selected in Step S18. A sub-routine “start date setting processing” is carried out in Step S19.

FIG. 14 is a flowchart for explaining operations of the sub-routine “start date setting processing” in Step S19 in the flowchart of FIG. 5B.

After entering this sub-routine, it is determined whether or not the sub-routine “selected camera” has been selected in Step S71. If the “selected camera” has not been selected, the system 10 shifts to Step S72, and if the “selected camera” has been selected, the system 10 shifts to Step S73.

In Step S72, start data information is transmitted to the cameras 40Ns belonging to the same network group as that of the selected camera. After this, the system 10 passes through this sub-routine to shift to step S7 in the flowchart of FIG. 5B, and enters a state of awaiting operations.

In Step S73, after the start date information has been transmitted to the selected camera 40N, the system 10 passes through this sub-routine to shift to Step S7 in the flowchart of FIG. 5B, and enters a state of awaiting operations.

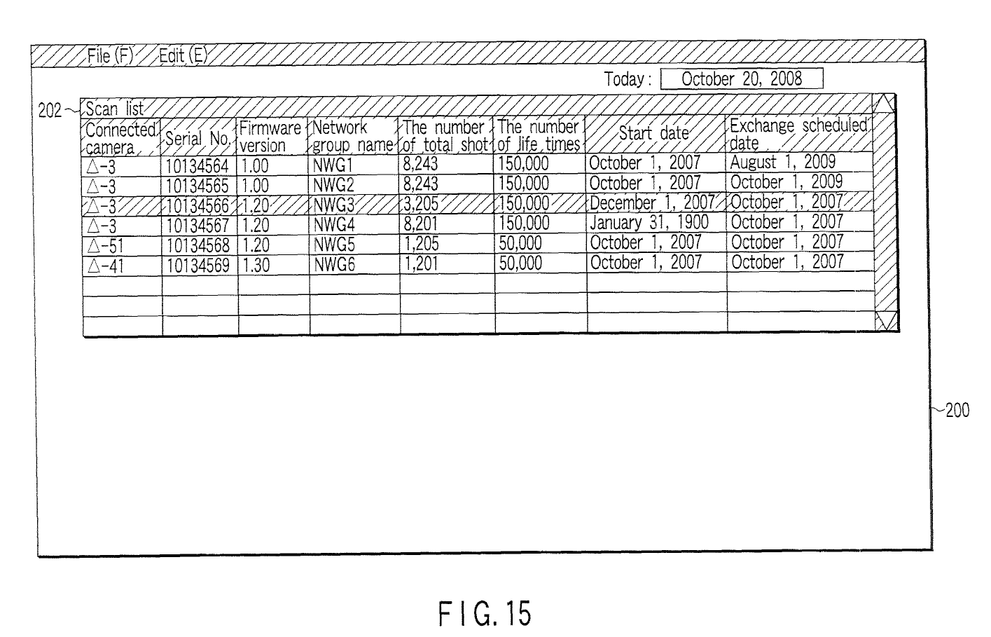

For instance, as shown in FIG. 15, when the camera 40N displayed in the scan list window 202 is made focus by the click of the left button of the mouse. Then, the start date is changed into a desired date.

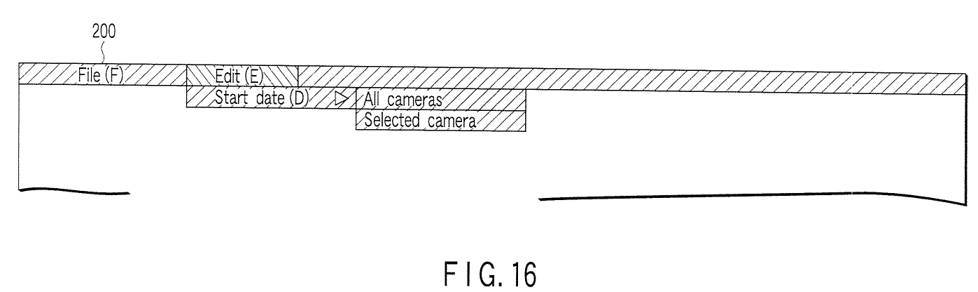

The “edition (E)”→“start date (D)”→“all cameras” are clicked by the left button of the mouse from the menu bar as is shown in FIG. 16. The application software then communicates with the camera 40N. The application software communicates with all the cameras among the cameras 40Ns displayed in the scan list window 202 on the application screen 200, and the setting displayed within the start date is set in all the cameras 40Ns displayed in the list window 202. The cameras 40Ns then store these states to transmit the information at every communication.

When the “edition (E)”→“start date (D)”→“selected camera” are clicked by the left button of the mouse, the application software communicates with the camera 40N. The application software communicates with the selected camera among the cameras 40Ns displayed in the scan list window 202 on the application screen 200, and the setting displayed within the start date is set in all the cameras 40Ns displayed in the list window 202. After this, the cameras 40Ns store these states to transmit the information at every communication.

In the case of the cameras which have been selected in the same way, different start dates may be set for individually selected cameras.

Further, in Steps S8-S11, if any one of the “open” menu, the scan menu, the camera setting menu, and the start date menu has not been selected, the system 10 shifts to Step S20, and it is detected that the “storage” or “storage with another name” has been selected. In Step S21, the system 10 carries out a sub-routine “storage processing”.

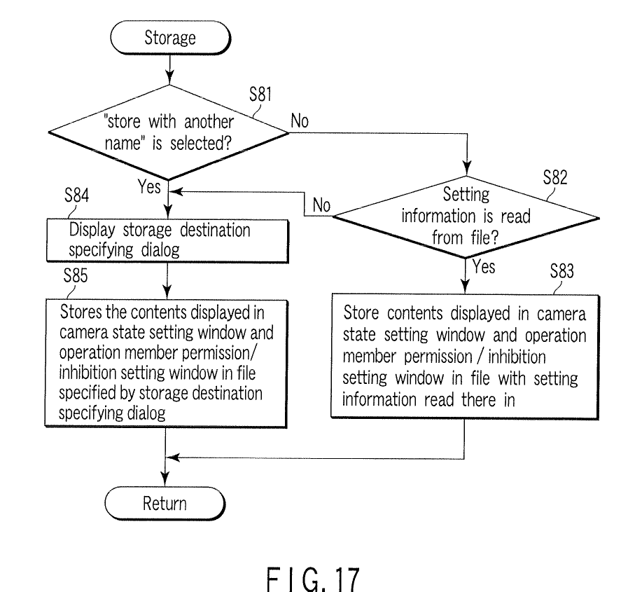

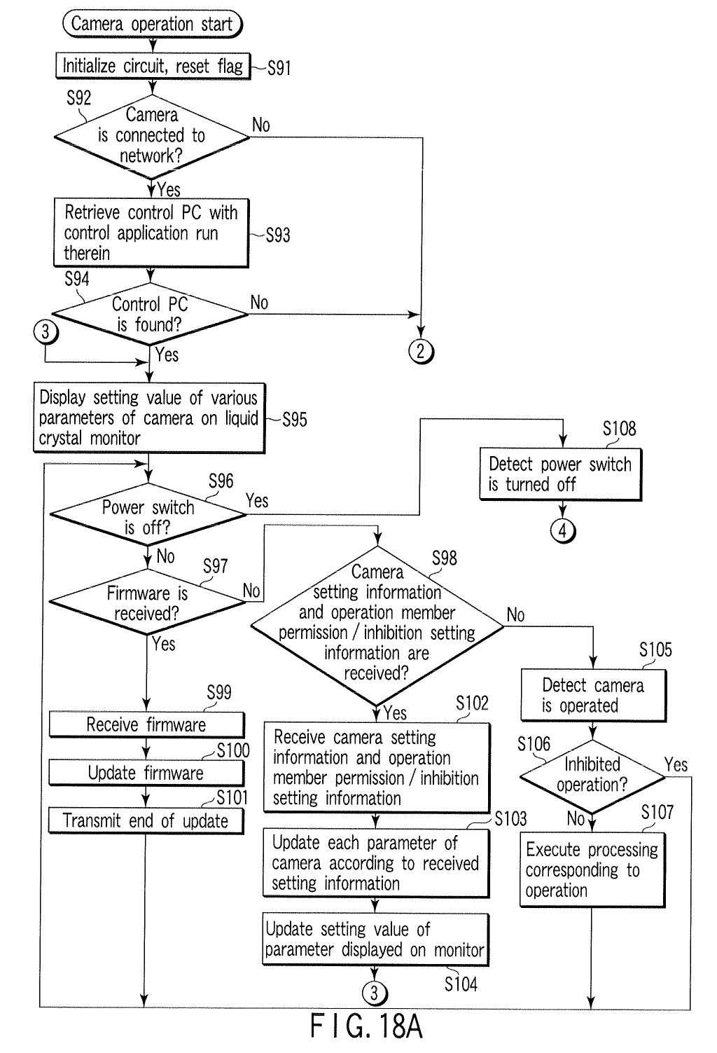

FIG. 17 shows a flowchart for explaining operations of the sub-routine “storage processing” in Step S21 in the flowchart of the FIG. 5B.

After entering this sub-routine, it is determined whether or not “store with another name (A)” has been selected in Step S81. If the “store with another name (A)” has not been selected, the system 10 shifts to Step S82 to determine whether or not the setting information has been read from the file. As a result, if the setting information has been read, the system 10 shifts to Step S83, and if the setting information has not been read, the system 10 shifts to Step S84.

In Step S83, contents displayed in the camera state setting window 208 and the operation member permission/inhibition setting window 206 are stored in the file with the setting information read therein. After this, the system 10 passes through this sub-routine to shift Step S7 in the flowchart of FIG. 5B, and the system 10 enters a state of awaiting operations.

If the “storage with another name (A)” has been selected in step S81, and if the setting information has been read from the file in Step S82, the system shifts to Step S84 to display a storage destination specifying dialog. Step S85 stores the contents, which have been displayed in the camera state setting window 208 and in the operation member permission/inhibition setting window 206, in the file specified by the storage destination specifying dialog. The system 10 then passes through this sub-routine to shift to Step S7 in the flowchart of FIG. 5B, and enters a state of awaiting operations.

If the end menu has been selected in Step S7, it is detected that the end menu has been selected in Step S22. Then, when the connection to the network 20 has been cut in Step S23, this sequence is terminated.

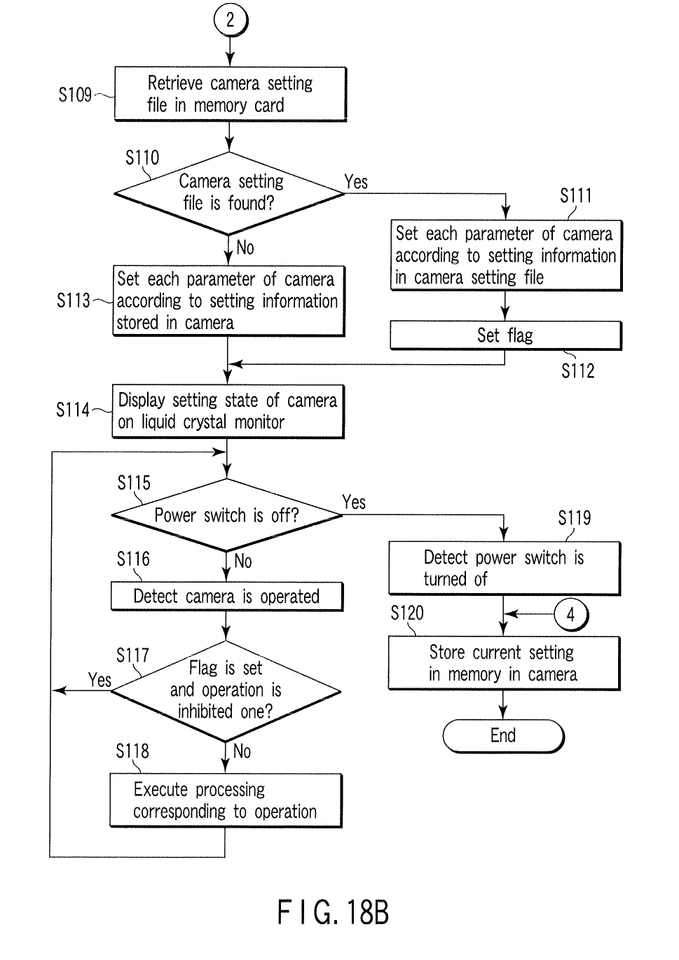

Operations of the cameras 40Ns connected to the network group will be described by referring to the flowcharts in FIGS. 18A and 18B.

When an operation of a certain camera 40N connected to the network group has been started, the circuit in the camera 40N is firstly initialized and flags are set in Step S91. In Step S92, it is determined whether or not the camera 40N has been connected to the network 20. If the camera 40N has not been connected to the network 20, the system 10 shifts to Step S109 mentioned later, and if the camera 40N has been connected to the network 20, the system 10 shifts to Step S93.

In Step S93, the PC 32 of the control unit 30 of which the application software is run is retrieved. As a result, in Step 94, it is determined whether or not the PC 32 of the control unit 30 has been recognized. If the PC 32 has been recognized, the system 10 shifts to Step S95, and if the PC 32 has not been recognized, the system 10 shifts to Step 109 mentioned later.

In Step S95, the setting values of various parameters (e.g., shutter speed, etc.) of the camera 40N are displayed on the liquid crystal monitor 122 of the camera 40N. A state of the power switch is determined in Step S96. If the power switch has been off, the system 10 shifts to Step S108 to detect that the power switch has been off. The system 10 then shifts to Step S120. Conversely, if the power switch has been on in Step S96, the system 10 shifts to Step S97.

It is determined whether or not the information on the firmware has been received in Step S97. If the information of the firmware has not been received, the system 10 shifts to Step S98 to determine whether or not the camera setting information and the operation member permission/inhibition information have been received.

If it is determined that the information of the firmware has been received in Step S97, the firmware is received in Step S99. Then, the version of the firmware is updated in Step S99. In Step S101, when the end of the update has been transmitted to the PC 32 via the network 20, the system 10 shifts to a state of waiting.

If it is determined that the camera setting information and the operation member permission/inhibition information have been received in Step S98, the system 10 shifts to step S102 to receive the camera setting information and the permission/inhibition setting information. Each parameter of the camera 40N is updated in accordance with the received setting information in Step S103. The setting values of the parameters displayed on the monitor of the PC 32 are updated in Step S104. The system 10 then shifts to Step S96 to enter a state of awaiting operations.

Further, if it is determined that the camera setting information and the operation member permission/inhibition information have not been received in Step S98, the system 10 shifts to Step S105 to detect that the camera 40N has been operated. In Step S106, it is determined whether or not the operations detected in Step S105 are inhibited operations as is shown in the table of FIG. 4.

If the operations are not ones which have been inhibited, processing corresponding to the operations is performed in Step S107. After this, the system 10 shifts to Step S96 to be in a state of waiting. Meanwhile, in Step S106, if it is determined that the operations are ones which have been inhibited, the operations are not carried out, and the system 10 shifts to Step S96 to be in a state of waiting without carrying out the operations.

A camera setting file in a memory card in the camera 40N is retrieved in Step S109. It is determined whether the camera setting file has been recognized in the next Step S110.

If the camera setting file has been recognized, the system 10 shifts to Step S111 to set each parameter of the camera 40N in accordance with the setting information in the camera setting file. After setting the flags in Step S112, the system 10 shifts to Step S114.

Conversely, if the camera setting file has not been recognized in Step S110, the system 10 shifts to Step S113 to set each parameter of the camera 40N in accordance with the setting information stored in the memory card of the camera 40N.

The setting state of the camera 40N is displayed on the monitor 122 of the camera 40N in Step S114. In Step S115, the state of the power switch is determined. If the power switch has been on, the system 10 shifts to Step S116 to detect that the camera 40N has been operated.

In Step S117, the flags are set, and it is determined whether or not the operations are inhibited ones. As a result, the flags are set and if the operations are inhibited ones, the camera operations are not performed and the system 10 shifts to Step S115 to be in the state of waiting. If the operations are not inhibited ones, the system 10 shifts to Step S118. The processing corresponding to the operations of the camera 40N is carried out in Step S118. Then, the system 10 shifts to Step S115 to be in a state of awaiting operations.

If it is determined that the power switch is off in Step S115, the system 10 shifts to Step S119 to detect that the power switch has been turned off. In Step S120, after storing the current setting in the memory of the camera 40N, this sequence ends.

The cameras connected to the network groups thus operate as described above.

While the aforementioned embodiment has been described as an example in which the operation information is transferred through the communication between the cameras 40N and the PC 32 via the network 20, the invention is not limited to this embodiment, and any general information medium, such as a DVD, a CD, a floppy disk (registered trade mark) can be used.

Although the foregoing operation information has been described as an example in which a communication is made between the PC 32 and the camera 40N, the invention is not limited to this embodiment, and the operation information may be transferred directly through a memory card.

While the embodiment of the invention has been described by referring to the drawings, the concrete configuration is not limited to the embodiment, and design changes may be made without departing from the spirit or scope of the genera inventive concept of the invention.

Further, the aforementioned embodiment includes various steps of the invention; various types of the invention can be formed by appropriately combining a plurality of constituent elements disclosed in the foregoing embodiment. If some of the constituent elements, for example, shown in the embodiment are omitted from all the elements, in a case in which the problems described in the section of “problem to be solved by the invention” may be resolved, and the effects described in the section of “object of the invention” may be obtained, the configuration from which the constituent elements are omitted may be embodied as the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A camera comprising:
a photographing unit which photographs an object;
an image memory which stores an image photographed with the photographing unit;
a plurality of operation members which receive operations
by a user;
a camera controller which controls operations of each unit of the camera including the photographing unit in response to the operations by the operation member;
a control information memory which stores control
information for deciding propriety of reception of operations for each operation member; and
a communication unit which transmits and receives
information to and from an external controller via a network, wherein
the camera controller stores the control information transmitted from the external control device and received by the communication unit in the control information memory, and when the operations of the operation member have been detected, determines the propriety of the reception of the operations by referring to the control information stored in the control information memory.

2. The camera according to claim 1, wherein
the camera controller transmits information for identifying the camera and information showing a state of the camera to the external controller through the communication unit.

3. A camera comprising:
a photographing unit which photographs an object;
an image memory which stores an image photographed with the photographing unit;
a plurality of operation members which receive operations by a user;
a camera controller which controls an operation of each unit of the camera including the photographing unit in response to the operation by the operation member;
a control information memory which stores control
information for deciding propriety of reception of the operations for each operation member; and
a storage medium mounting unit which mounts an attachable and detachable storage medium thereon; wherein
the camera controller reads the control information from the storage medium mounted on the storage medium mounting unit to store the control information in the control information memory, and when the operations of the operation member have been detected, determines the propriety of the reception of the operations by referring to the control information stored in the control information memory.

4. The camera, according to claim 3, wherein
the image memory is equivalent to the storage medium.

5. A camera system configured to include at least one camera connected to a network, and a control device connected to the network, wherein the camera comprises:
a photographing unit which photographs an object;
an image memory which stores an image photographed by the photographing unit;
a plurality of operation members which receive operations by a user;
a camera controller which controls an operation of each unit of the camera including the photographing unit in response to the operations of the operation member;
a control information memory which stores control information for deciding propriety of reception of operations for each operation member; and
a first communication unit which transmits and receives information to and from the control device via the network; wherein
the control device comprises:
a second communication unit which communicates with the camera via the network;
a selection unit which selects as least one of the cameras connected to the network; and
an operation setting unit which generates the control information for deciding the propriety of the reception of the operations for each operation member of the camera selected by the selection unit,
the control device makes the second communication unit transmit the control information generated from the operation setting unit to the camera selected by the selection unit; and
the camera controller stores the control information received by the first communication unit in the control information memory, and determines the propriety of the reception of operations of each operation member by referring to the control information stored in the control information memory for each operation of the operation members in the camera selected by the selection unit.

6. The camera system according to claim 5, wherein
the camera further comprises:
a parameter memory which stores a setting value of a parameter for operating the camera,
the control device further comprises:
a parameter acquisition unit which acquires the setting value of the parameter from at least one of cameras connected to the network; and a parameter transmission unit which transmits the setting value of the parameter to the selected camera, and
the camera controller receives the setting value of the parameter transmitted from the control device to store the setting value in the parameter memory in the camera.

7. The camera system according to claim 5, wherein
the camera further comprises:
a program memory which stores firmware for operating the camera, wherein
the control device further comprises:
a camera information specifying unit which acquires information specifying a type of the camera and information specifying a version of the firmware from at least one of the cameras connected to the network, and
the selection unit selects cameras, in the control device, by specifying the type, and the operation setting unit updates into the firmware of the specified version before transmitting operation propriety data for cameras differing in version of the firmware of the cameras selected by the selection unit if the versions of the firmware of the selected cameras are different from one another.

8. The camera system according to claim 7, wherein
the camera further comprises a program memory which stores firmware for operating the camera;
the control device further comprises a parameter acquisition unit which acquires setting the parameter from the camera connected to the network; and a parameter transmission unit which transmits the setting value of the parameter to the selected camera,
the camera controller stores the setting value of the parameter transmitted from the control device received by the first communication unit in the parameter memory in the camera.

9. The camera according to claim 5, wherein
the camera further comprises a storage medium which is attachable and detachable to and from the camera to store the control information; and a reading unit which reads information stored in the storage medium, wherein
the camera controller decides the priority of the reception of the operations of the operation members by referring to the storage medium for each operation of the operation members;
the reading unit reads the control information stored in a prescribed format in the storage device to store the control information in the control information memory; and
the camera controller decides the propriety of the reception of the operations of each of the operation members by referring to operation propriety data stored in the storage medium for each operation of the operation members.

10. The camera system according to claim 5, wherein
at least one of the cameras connected to the network is included in sub-network groups each composed of at least one camera.

11. The camera system according to claim 5, wherein
the control device includes a master camera for operating the cameras connected to the network.
